(19) United States
(12) Patent Application Publication
(10) Pub. No.: US 2009/0119932 A1
(43) Pub. Date: May 14, 2009

(54) Curved and toothed cutting blade for a trimmer and a grinding wheel for manufacturing therefor

(75) Inventor: Tung Yan LAU, N.T. (HK)

Correspondence Address: ERIC CHAN, 42 PIN OAKS DRIVE, PHOENIXVILLE, PA, 19460, US

(73) Assignee: SPECIALIFE INDUSTRIES LIMITED, N.T. (HK)

(21) Appl. No.: 11/938,255

(22) Filed: Nov. 10, 2007

(51) Int. Cl. B26B 19/38; B26B 19/06

(52) U.S. Cl. 30/355; 30/356; 30/357; 451/547; 76/37

(57) ABSTRACT

A curved and toothed cutting blade for a trimmer comprising a base body having at least a connecting member for mounting onto a trimmer and a longitudinal cutting edge on one side which is symmetrically concave downward and has teeth, wherein the curve of the cutting edge is in the form of a segment of the interior of a circular arc of a lens with the two interior angles of any teeth not having different degrees of angle and the dent in between any two teeth being not perpendicular to the base pitch of the tips of the two teeth and slanted towards the center point of the curve of the cutting edge; and a grinding wheel for manufacturing the cutting blade, wherein the cutting blade is manufactured by a grinding wheel which is in the form of a lens with the two endpoints truncated with diameter being the largest in the middle and gradually decreasing towards the two ends and the surface of which has grooves of sizes and shapes which correspond to the sizes and shapes of the teeth of the cutting blade. The manufacturing process is simple and of low cost.

### BACKGROUND OF THE INVENTION

The present invention relates to a curved and toothed cutting blade for a trimmer and a grinding wheel for manufacturing said cutting blade.

Conventional toothed cutting blades for trimmers are straight and are manufactured by means of grinders. A typical grinder has a grinding wheel which comprises a plurality of axially spaced circular grinding disks connected together by a rotatable shaft passing through the centers of the respective grinding disks. The teeth of the blade are formed and sharpened by grinding the blade against the grinding wheel. The manufacturing process is simple and of low cost. However, such grinders can only manufacture straight cutting blades but not curved cutting blades.

Curved cutting blades are preferred for trimmers as it is ergonomic to make easier and faster adjustments to hair length according to the curvature of a portion of a body surface, for example, a human head. As illustrated in FIGS. 1 and 2, a curved cutting blade is symmetrically concave downward and has teeth, and the curve of the cutting edge is in the form of an arc with the two interior angles of any teeth having the same degrees of angle and the dent in between any two teeth being perpendicular to the base pitch of the tips of the two teeth. The existing curved and toothed cutting blades are manufactured centrifugally and sequentially one tooth after the other by grinders. The cheaper manufacturing method by way of mechanical honing of all teeth at one time is not feasible. Therefore, the manufacturing costs of the curved toothed cutting blades remain to be substantially higher than those of the straight toothed cutting blades.

### BRIEF SUMMARY OF THE INVENTION

In view of the aforesaid disadvantages now present in the prior art, the object of the present invention is to provide a kind of the curved and toothed cutting blades for trimmers which can be efficiently manufactured by simply grinding against a grinding wheel and is thus susceptible of low manufacturing costs.

To attain this, the present invention generally comprises a curved and toothed cutting blade for a trimmer comprising a base body having at least a connecting member for mounting onto a trimmer and a longitudinal cutting edge on one side which is symmetrically concave downward and has teeth, wherein the curve of the cutting edge is in the form of a segment of the interior of a circular arc of a lens with the two interior angles of any teeth not having different degrees of angle and the dent in between any two teeth being not perpendicular to the base pitch of the tips of the two teeth and slanted towards the center point of the curve of the cutting edge.

The curve of the cutting edge corresponds approximately to the curvature of a portion of a body surface such as a portion of a human head so that the cutting blade can fit the surface curvature of a body surface such as a human head to be trimmed, and it is therefore ergonomic to make easier and faster adjustments to hair length according to the curvature of the portion of the body surface. After trimming, the hair remaining on the body surface can be of substantially identical length, thereby creating a tidy cut which is very difficult to be achieved by a conventional straight toothed blade.

The present invention further provides a grinding wheel for manufacturing said cutting blade, wherein the grinding wheel is in the form of a lens with the two endpoints truncated with diameter being the largest in the middle and gradually decreasing towards the two ends and the surface of which has grooves of sizes and shapes which correspond to the sizes and shapes of the teeth of the cutting blade.

The grinding wheel may comprise a one-piece tool with the grooves being cut onto its surface and a rotatable shaft passing through its center.

Alternatively, the grinding wheel may comprise a plurality of axially spaced circular grinding disks with the alternate disks being of shorter diameters and all grinding disks being connected together by a rotatable shaft passing through the centers of the respective grinding disks, and the alternate disks of shorter diameters forming the grooves of the grinding wheel.

The grinder with the grinding wheel of the present invention operates in the same way as a conventional grinder does for manufacturing straight toothed cutting blades for trimmers known in the art. The curve and the teeth of the cutting blade are formed and sharpened by grinding the blade against the grinding wheel. The manufacturing process is simple and of low cost.

Further objects, features, and advantages of the invention will become more apparent from the following description and the appended claims with reference to the accompanying drawings, all of which form a part of this specification. It should be understood, however, that the description and the specific example while representing the preferred embodiment is given by way of illustration only.

### BRIEF DESCRIPTION OF THE DRAWINGS

FIG. 1 is a front view of a conventional curved and toothed cutting blade of the prior art.

FIG. 2 is an enlarged view of the teeth of the cutting blade of the prior art as shown in FIG. 1.

FIG. 3 is a curved and toothed cutting blade of the present invention.

FIG. 4 is an enlarged view of the teeth of the cutting blade as shown in FIG. 3.

FIG. 5 is a section view of the cutting blade as shown in FIG. 3 and a corresponding grinding wheel for manufacturing therefor.

FIG. 6 is a perspective view of FIG. 5.

FIG. 7 is a perspective view of a trimmer with the curved and toothed cutting blades of the present invention.

FIG. 8 is an enlarged view of the curved and toothed cutting blades of the trimmer as shown in FIG. 7.

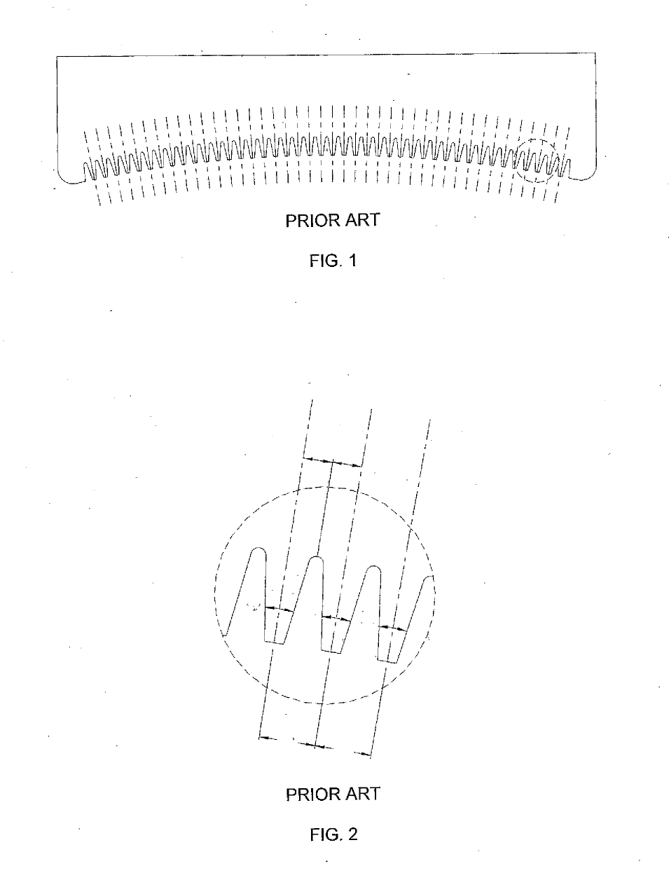

### DETAILED DESCRIPTION OF THE INVENTION

The present invention is further described in detail with the following embodiment and the accompanying drawings.

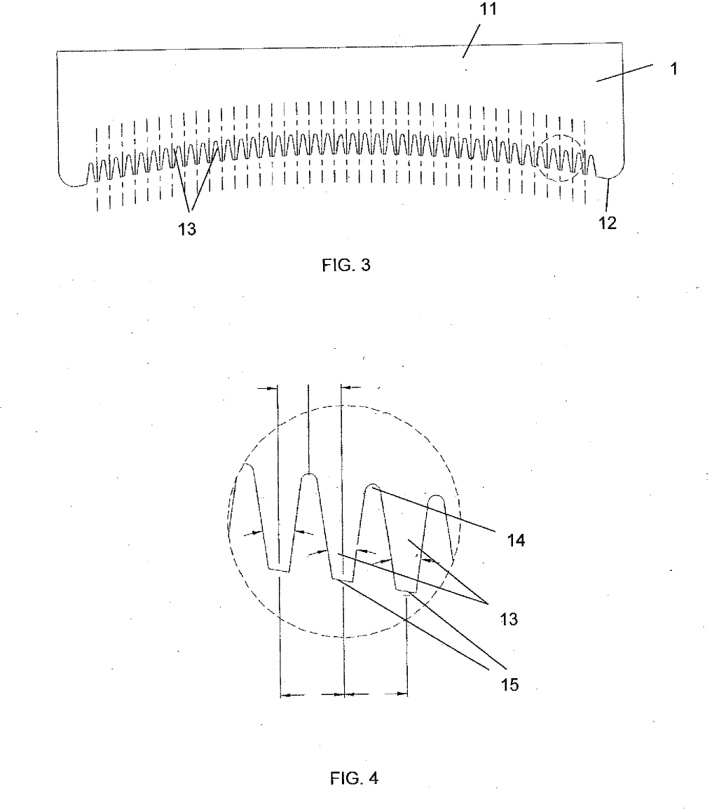

As illustrated in FIGS. 3 and 4, the present invention generally comprises a curved and toothed cutting blade 1 for a trimmer comprising a base body 11 having at least a connecting member, not shown herein, for mounting onto a trimmer and a longitudinal cutting edge 12 on one side which is symmetrically concave downward and has teeth 13, wherein the curve of the cutting edge 12 is in the form of a segment of the interior of a circular arc of a lens with the two interior angles of any teeth 13 not having different degrees of angle and the dent 14 in between any two teeth 13 being not perpendicular to the base pitch of the tips 15 of the two teeth 13 and slanted towards the center point of the curve of the cutting edge 12. The curve of the cutting edge 12 corresponds approximately to the curvature of a portion of a human head in this embodiment. In other embodiments, the curve of the cuffing edge 12 may correspond approximately to the curvature of a portion of a body surface other than the human head.

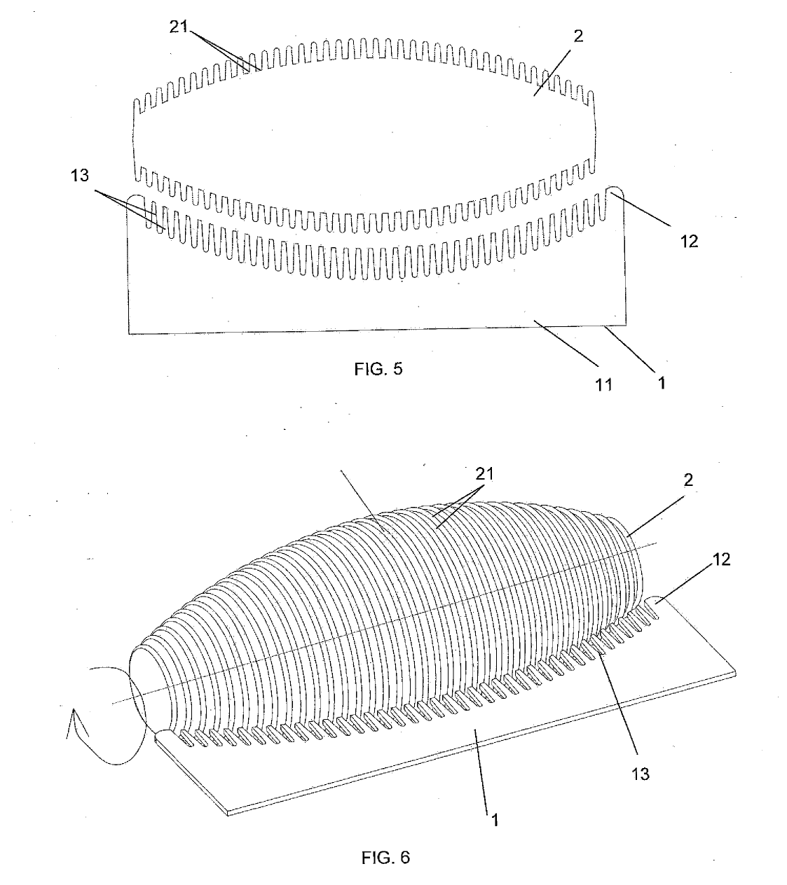

As illustrated in FIGS. 5 and 6, the present invention further comprises a grinding wheel 2 for manufacturing the cutting blade 1 which is in the form of a lens with the two endpoints truncated with diameter being the largest in the middle and gradually decreasing towards the two ends and the surface of which has grooves 21 of sizes and shapes which correspond to the sizes and shapes of the teeth 13 of the cuffing blade 1. In this embodiment, the grinding wheel 2 comprises a one-piece tool with the grooves 21 being cut onto its surface and a rotatable shaft passing through its center, not shown herein. In other embodiments, the grinding wheel 2 may comprise a plurality of axially spaced circular grinding disks with the alternate disks being of shorter diameters and all grinding disks being connected together by a rotatable shaft passing through the centers of the respective grinding disks, and the alternate disks of shorter diameters forming the grooves 21 of the grinding wheel 2.

The grinding wheel 2 is to be installed onto a grinder and the grinder operates in the same way as a conventional grinder does for manufacturing straight toothed cutting blades for trimmers known in the art. The grinder with the grinding wheel 2 of the present invention can manufacture the curved and toothed cutting blade 1 which can be mounted onto a trimmer for trimming. The curve and the teeth 13 of the cutting blade 1 are formed and sharpened by grinding the blade 1 against the grinding wheel 2. The manufacturing process is simple and of low cost.

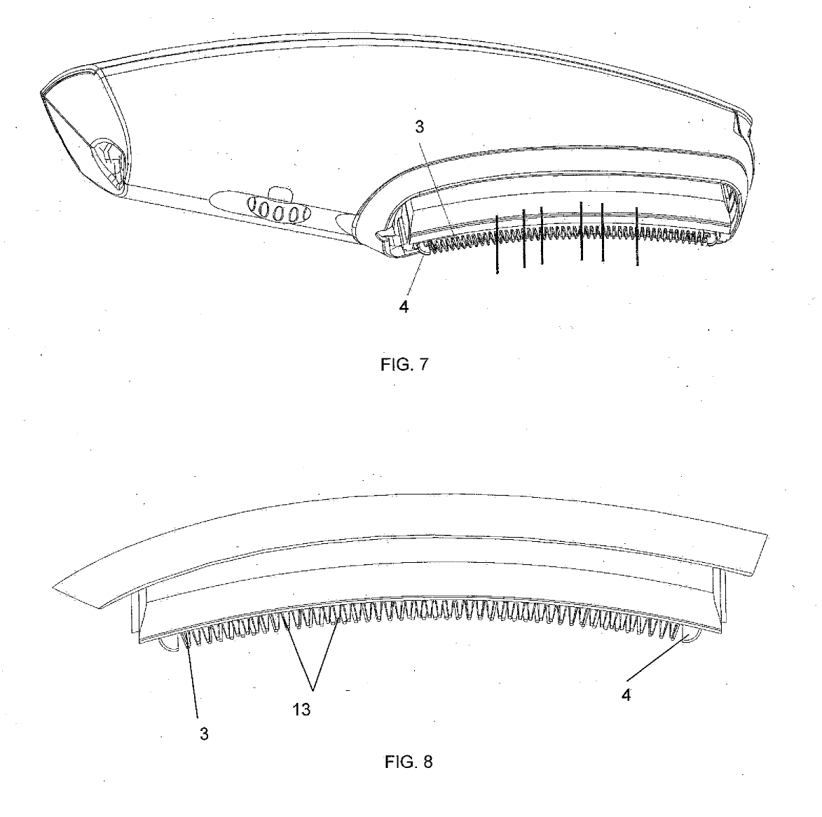

FIGS. 7 and 8 further illustrate the application of the curved and toothed cutting blade 1 in a trimmer. In this embodiment, two curved and toothed cuffing blades 1 are mounted onto the trimmer, one as the moving blade 3 and the other as the corresponding stationary blade 4. The moving blade 3 and the stationary blade 4 reciprocate against each other during trimming. In other embodiments, not shown herein, the moving blade 3 may pair up with another moving blade or alternatively with a moving or stationary curved and toothed cutting blade of the know art. Further, the lengths of the two cutting blades in a pair may be identical or different, and the curvatures of the two may also be identical or different.

It is ergonomic to make easier and faster adjustments to hair length according to the curvature of the portion of the body surface. The user may simply move the trimmer in a direction that the cuffing edge 12 moves in parallel along the curvature of a portion of a body surface such as a human head to be trimmed. The hair on that part of the body will be trimmed and the hair remaining on the body part is of substantially identical length, thereby creating a tidy cut which is very difficult to be achieved by a conventional straight toothed blade.

The above embodiment is a preferred embodiment of the present invention. The present invention is capable of other embodiments and is not limited by the above embodiment. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A curved and toothed cutting blade for a trimmer comprising a base body having at least a connecting member for mounting onto a trimmer and a longitudinal cutting edge on one side which is symmetrically concave downward and has teeth, wherein the curve of the cutting edge is in the form of a segment of the interior of a circular arc of a lens with the two interior angles of any teeth not having different degrees of angle and the dent in between any two teeth being not perpendicular to the base pitch of the tips of the two teeth and slanted towards the center point of the curve of the cutting edge.

2. The cuffing blade according to claim 1, wherein the curve of the cutting edge corresponds approximately to the curvature of a portion of a body surface.

3. The cutting blade according to claim 1, wherein the curve of the cutting edge corresponds approximately to the curvature of a portion of a human head.

4. A grinding wheel for manufacturing the cutting blade according to claim 1, wherein the cutting blade is manufactured by a grinding wheel which is in the form of a lens with the two endpoints truncated with diameter being the largest in the middle and gradually decreasing towards the two ends and the surface of which has grooves of sizes and shapes which correspond to the sizes and shapes of the teeth of the cutting blade.

5. A grinding wheel according to claim 4, wherein the grinding wheel comprises a one-piece tool with the grooves being cut onto its surface and a rotatable shaft passing through its center.

6. A grinding wheel according to claim 4, wherein the grinding wheel comprises a plurality of axially spaced circular grinding disks with the alternate disks being of shorter diameters and all grinding disks being connected together by a rotatable shaft passing through the centers of the respective grinding disks, and the alternate disks of shorter diameters forming the grooves of the grinding wheel.
